(19) United States
(12) Patent Application Publication
(10) Pub. No.: US 2021/0357695 A1
(43) Pub. Date: Nov. 18, 2021

(54) DEVICE AND METHOD FOR SUPPORTING GENERATION OF LEARNING DATASET

(71) Applicant: HITACHI, LTD., Tokyo (JP)

(72) Inventors: Hironobu KURUMA, Tokyo (JP); Naoto SATO, Tokyo (JP); Makoto ISHIKAWA, Tokyo (JP); Kyohei OYAMA, Tokyo (JP); Hideto NOGUCHI, Tokyo (JP)

(21) Appl. No.: 17/201,035

(22) Filed: Mar. 15, 2021

(30) Foreign Application Priority Data
May 14, 2020 (JP) 2020-085448

(51) Int. Cl. G06K 9/62; G06N 3/08

(52) U.S. Cl. CPC G06K 9/6257; G06N 3/08; G06K 9/6265

(57) ABSTRACT

A learning dataset generation support device 100 is configured to include: a storage device 101 that is configured to store a plurality of pieces of learning data used for supervised machine learning along with correct answer labels; and a computing device 104 that is configured to perform a process of sequentially acquiring the pieces of learning data from the storage device to extract feature vectors, an editing process of adding and/or deleting a feature vector according to a predetermined algorithm, and a process of generating learning data from the edited feature vectors.

### CROSS-REFERENCE TO RELATED APPLICATION

This application claims priority pursuant to Japanese patent application No. 2020-085448, filed on May 14, 2020, the entire disclosure of which is incorporated herein by reference.

### BACKGROUND

### Technical Field

The present disclosure relates to a device and a method for supporting the generation of a learning dataset.

### Related Art

In supervised machine learning among machine learning, data are collected from the real world, and learning data (training data and test data) each having a correct answer label, which is an expected output in response to input of the collected data, are generated. In addition, the above-mentioned training data are used as teacher data to make a model learn the correspondence between the correct answer label and the feature of the data, and the test data are given to the model to evaluate the learning accuracy.

In order to ensure the accuracy of the above-mentioned model, such learning data in machine learning needs to appropriately cover an assumed input data space and be given appropriate labels. Accordingly, it is important to generate learning data as appropriate.

As a conventional technique related to data generation, for example, there is known a method of constructing an encoder and a decoder that newly generate data similar to given data by a neural network (see Variational Auto Encoder (VAE) Kingma, D. P., Welling, M.: Auto Encoding Variational Bayes, arXiv: 1312.6114 v10 (2014)).

In this technique in which the encoder and the decoder are constructed, the encoder infers hidden variables of data from a given dataset, normalizes the distribution of their values to a Gaussian distribution, and outputs the resulting distribution; the decoder generates data on the basis of the values of the hidden variables sampled from the distribution.

With such a technique, it is possible to generate new data similar to the original data by inputting the values of the hidden variables into the decoder.

For example, there has also been proposed a method for generating training data with no correct answer label for reinforcement learning (or semi-reinforcement learning) of an encoder and a decoder so as to generate more natural data (see WO201906783A1).

In this technique, the data generated by the decoder is evaluated for (generally multiple) goals and fed back to the training of the decoder. With such a technique, it is possible to generate new useful data under a given goal.

It is difficult to control the progress of learning with a learning dataset collected in a simple manner, which may result in unintended learning. For example, problems may occur such as lack of learning data, careless proximity of learning data with different correct answer labels, and features different from the learning intention being dominant.

However, the conventional techniques require to specify the data to be generated by the values of the hidden variables, and thus are not suitable for the application of learning data generation that aims at the intended learning. Such conventional techniques also have a problem of no mechanism for analyzing and editing data in a statistical space (stochastic layer), and thus makes it difficult to generate learning data having correct answer labels suitable for supervised machine learning.

Therefore, an objective of the present disclosure is to provide a technique for efficiently and appropriately refining a learning dataset used for supervised machine learning.

### SUMMARY

A learning dataset generation support device of the present disclosure to solve the above objective comprises: a storage device that is configured to store a plurality of pieces of learning data used for supervised machine learning along with correct answer labels; and a computing device that is configured to perform a process of sequentially acquiring the pieces of learning data from the storage device to extract feature vectors, an editing process of adding and/or deleting a feature vector according to a predetermined algorithm, and a process of generating learning data from the edited feature vectors.

A learning dataset generation support method of this disclosure performed by an information processing device including a storage device that is configured to store a plurality of pieces of learning data used for supervised machine learning along with correct answer labels, the learning dataset generation support method comprises a process of sequentially acquiring the pieces of learning data from the storage device to extract feature vectors, an editing process of adding and/or deleting a feature vector according to a predetermined algorithm, and a process of generating learning data from the edited feature vectors.

According to the present disclosure, it is possible to efficiently and appropriately refine a learning dataset used for supervised machine learning.

### BRIEF DESCRIPTION OF DRAWINGS

FIG. 1 is a diagram illustrating a configuration example of a learning dataset generation support device according to an embodiment;

FIG. 2 is a diagram illustrating a hardware configuration example of the learning dataset generation support device according to the embodiment;

FIG. 3 illustrates a flow example of a learning dataset generation support method according to the embodiment;

FIG. 4A illustrates a flow example of the learning dataset generation support method according to the embodiment;

FIG. 4B illustrates a flow example of the learning dataset generation support method according to the embodiment;

FIG. 5A illustrates a flow example of the learning dataset generation support method according to the embodiment;

FIG. 5B illustrates a flow example of the learning dataset generation support method according to the embodiment;

FIG. 5C illustrates a flow example of the learning dataset generation support method according to the embodiment;

FIG. 5D illustrates a flow example of the learning dataset generation support method according to the embodiment;

FIG. 5E illustrates a flow example of the learning dataset generation support method according to the embodiment;

FIG. 5F illustrates a flow example of the learning dataset generation support method according to the embodiment;

FIG. 6A illustrates a flow example of the learning dataset generation support method according to the embodiment;

FIG. 6B illustrates a flow example of the learning dataset generation support method according to the embodiment;

FIG. 7 illustrates a flow example of the learning dataset generation support method according to the embodiment;

FIG. 8 illustrates a flow example of the learning dataset generation support method according to the embodiment;

FIG. 9 illustrates a flow example of the learning dataset generation support method according to the embodiment;

FIG. 10 illustrates a flow example of the learning dataset generation support method according to the embodiment;

FIG. 11 illustrates a flow example of the learning dataset generation support method according to the embodiment;

FIG. 12 is an explanatory diagram about a process of collecting feature vectors in the embodiment;

FIG. 13 is an explanatory diagram about a process of editing feature vectors in the embodiment;

FIG. 14 illustrates an example of a feature vector display screen in the embodiment;

FIG. 15 illustrates an example of an editing operation on a feature vector display screen in the embodiment;

FIG. 16 is an explanatory diagram about refining a learning dataset in the embodiment;

FIG. 17 is an explanatory diagram about generating outlier test data in the embodiment;

FIG. 18 is an explanatory diagram about generating continuous learning data in the embodiment; and

FIG. 19 illustrates an example of generated continuous learning data in the embodiment.

### DESCRIPTION OF EMBODIMENTS

<<Overall Configuration>>

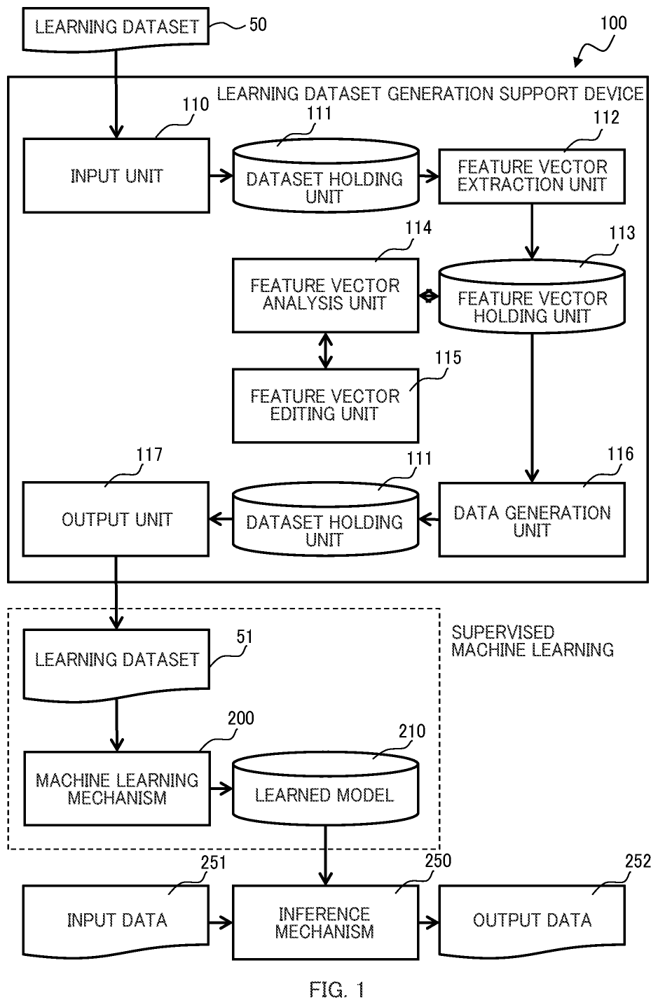

An embodiment of the present disclosure will be described below in detail with reference to the drawings. FIG. 1 is a diagram illustrating a configuration example of a learning dataset generation support device 100 according to the embodiment.

The learning dataset generation support device 100 illustrated in FIG. 1 is a computer device that makes it possible to efficiently and appropriately refine a learning dataset used for supervised machine learning.

The learning dataset generation support device 100 includes an input unit 110, a dataset holding unit 111, a feature vector extraction unit 112, a feature vector holding unit 113, a feature vector analysis unit 114, a feature vector editing unit 115, a data generation unit 116, and an output unit 117 to refine a learning dataset 51 used for supervised learning based on an analysis on a feature space.

The learning dataset generation support device 100 acquires each piece of learning data (a pair of data and a correct answer label) of a learning dataset 50 to be processed via the input unit 110 (or a predetermined terminal operated by an operator, etc.), assigns an identification number to the piece of learning data, and holds the resulting piece of data in the dataset holding unit 111.

The learning dataset generation support device 100 also inputs each piece of learning data of the learning dataset 50 held by the dataset holding unit 111 into the feature vector extraction unit 112 to extract a feature vector. The feature vector extraction unit 112 includes (or may from an external device call and use), for example, an engine of a neural network to perform feature vector extraction using the engine.

Further, the learning dataset generation support device 100 temporarily stores the feature vector data extracted as described above in the feature vector holding unit 113. The feature vector data is to be processed by the feature vector analysis unit 114 (and also the feature vector editing unit 115 as needed).

In the learning dataset generation support device 100, the feature vector analysis unit 114 collects the feature vectors associated with their correct answer labels, and identifies feature vectors to be deleted and added according to a predetermined determination value.

Further, in the learning dataset generation support device 100, the feature vector editing unit 115 executes an editing process including deleting the feature vectors to be deleted and adding the feature vectors to be added, which are identified by the feature vector analysis unit 114, so that the result of the process is reflected in the feature vector holding unit 113.

Further, the learning dataset generation support device 100 generates pieces of learning data for the feature vectors held in the feature vector holding unit 113 by the engine of the neural network in the data generation unit 116.

Further, the learning dataset generation support device 100 stores the pieces of learning data and their correct answer labels generated as described above in the dataset holding unit 111.

Note that the learning dataset generation support device 100 evaluates the learning dataset updated in the dataset holding unit 111, and outputs, by the output unit 117, the updated learning dataset to a machine learning mechanism 200 when the result of evaluation satisfies a predetermined threshold value. On the other hand, when the result of evaluation does not satisfy the predetermined threshold value, the above steps are repeated.

In response to this, the machine learning mechanism 200 performs machine learning on the learning dataset 51 obtained as an input from the learning dataset generation support device 100 to obtain a trained model 210.

On the other hand, an inference mechanism 250 obtains the trained model 210, receives input data 251, which is actual data, for the trained model 210, and obtains output data 252.

<<Hardware Configuration>>

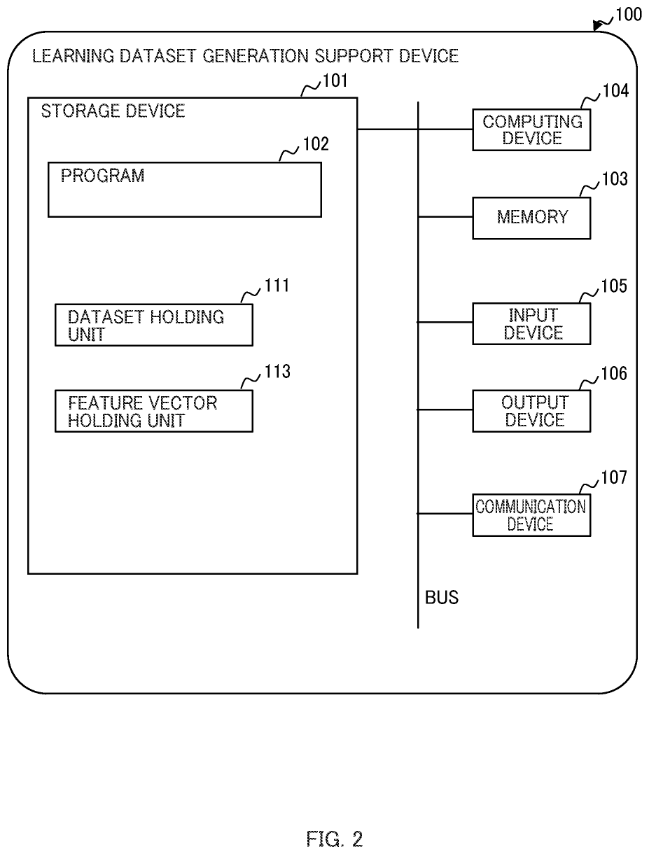

A hardware configuration of the learning dataset generation support device 100 according to the present embodiment is as illustrated in FIG. 2. Specifically, the learning dataset generation support device 100 includes a storage device 101, a memory 103, a computing device 104, an input device 105, an output device 106, and a communication device 107.

Of these devices, the storage device 101 includes a suitable non-volatile storage element such as an SSD (Solid State Drive) or a hard disk drive.

The memory 103 includes a volatile storage element such as a RAM.

The computing device 104 is a CPU that loads a program 102 stored in the storage device 101 into the memory 103 to execute them so that the learning dataset generation support device 100 is integrally controlled and various determinations, computation, and control processing are performed. The program 102 includes a neural network engine 1021 that implements an encoder and decoder.

The input device 105 is a suitable device such as a keyboard, a mouse, or a microphone for receiving a key input or a voice input from an operator.

The output device 106 is a suitable device such as a display or a speaker for displaying processed data in the computing device 104.

The communication device 107 is a network interface card that handles a process of communicating with another device (e.g., the machine learning mechanism 200, etc.) via a suitable network.

Note that the dataset holding unit 111 and the feature vector holding unit 113 are implemented in the storage device 101 or the memory 103.

<<Learning Dataset Generation Support Method: Main Flow>>

An actual procedure of a learning dataset generation support method according to the present embodiment will be described below with reference to the drawings. Various operations corresponding to the learning dataset generation support method described below are implemented by the learning dataset generation support device 100 reading a program into a memory or the like and executing it. The program is composed of codes for performing various operations described below.

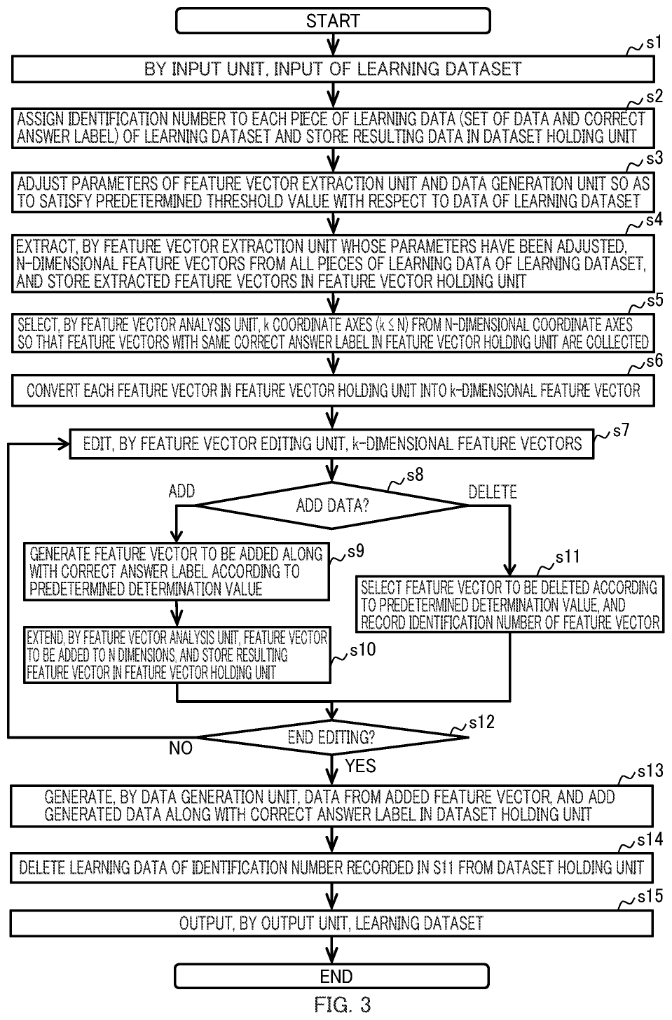

FIG. 3 illustrates an example of the main flow of the learning dataset generation support method according to the embodiment. Details of steps indicated in this flow will be described in separate flows. FIG. 3 illustrates the outline of the whole process.

Now, the learning dataset generation support device 100 first receives and acquires input of a learning dataset from the input unit 110 (s1).

Further, the learning dataset generation support device 100 assigns an identification number to each piece of learning data (a set of data and a correct answer label) of the learning dataset and stores the resulting data in the dataset holding unit 111 (s2).

Further, the learning dataset generation support device 100 adjusts parameters of the feature vector extraction unit 112 and the data generation unit 116 so as to satisfy a predetermined threshold value with respect to the data of the learning dataset (s3).

Further, the learning dataset generation support device 100 extracts, by the feature vector extraction unit 112 whose parameters have been adjusted, N-dimensional feature vectors from all the pieces of learning data of the learning dataset, and stores the extracted feature vectors in the feature vector holding unit 113 (s4).

Further, the learning dataset generation support device 100 selects, by the feature vector analysis unit 114, k coordinate axes (k≤N) from the N-dimensional coordinate axes so that feature vectors with the same correct answer label in the feature vector holding unit 113 are collected (s5).

Further, the learning dataset generation support device 100 converts each feature vector in the feature vector holding unit 113 into a k-dimensional feature vector (s6).

Further, the learning dataset generation support device 100 edits, by the feature vector editing unit 115, the k-dimensional feature vectors (s7).

Further, the learning dataset generation support device 100 determines whether or not data of a feature vector needs to be added as a result of the editing (s8).

When data is to be added as a result of the determination (s8: ADD), the learning dataset generation support device 100 generates the feature vector to be added along with a correct answer label according to a predetermined determination value (s9).

Further, the learning dataset generation support device 100 extends, by the feature vector analysis unit 114, the feature vector to be added to N dimensions, and stores the resulting feature vector in the feature vector holding unit 113 (s10).

On the other hand, when data is to be deleted as a result of the determination instead of addition of data (s8: DELETE), the learning dataset generation support device 100 selects a feature vector to be deleted according to a predetermined determination value, and records the identification number of the feature vector in, for example, the memory 103 (s11).

Further, the learning dataset generation support device 100 determines whether the editing process is completed by the steps having been performed at this point, for example, based on the presence/absence of an instruction from the operator or the presence/absence of a target not edited yet in s7 (s12). If the editing process is not completed (s12: NO), the processing is returned to s7.

On the other hand, if the editing process is completed as a result of the determination (s12: YES), the processing in the learning dataset generation support device 100 proceeds to s13.

Further, the learning dataset generation support device 100 generates, by the data generation unit 116, data from the added feature vector, and adds the generated data along with a correct answer label in the dataset holding unit 11 (s13).

Further, the learning dataset generation support device 100 deletes the learning data of the identification number recorded in the memory 103 in s11 from the dataset holding unit 111 (s14).

Further, the learning dataset generation support device 100 outputs, by the output unit 117, the learning dataset from the dataset holding unit 111 (s15), and then the processing ends.

<<Learning Dataset Generation Support Method: Parameter Adjustment Flow>>

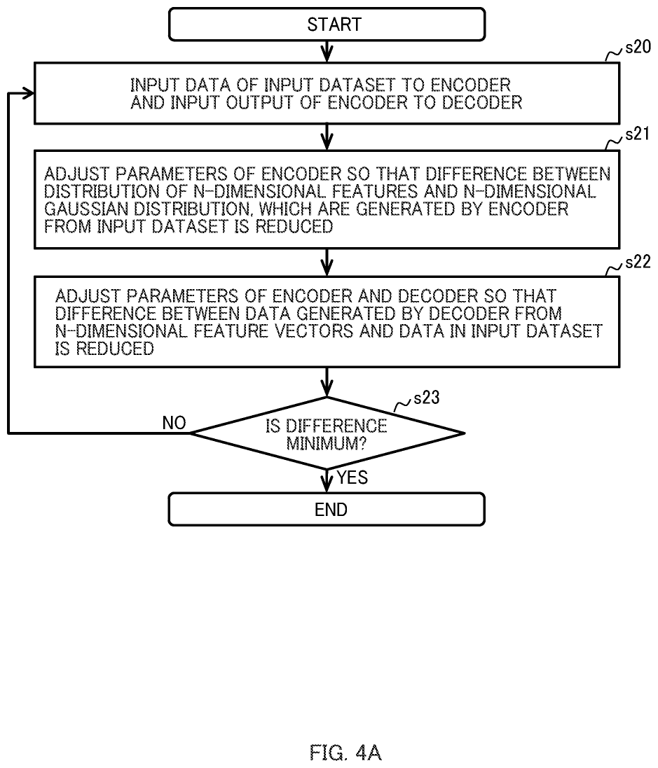

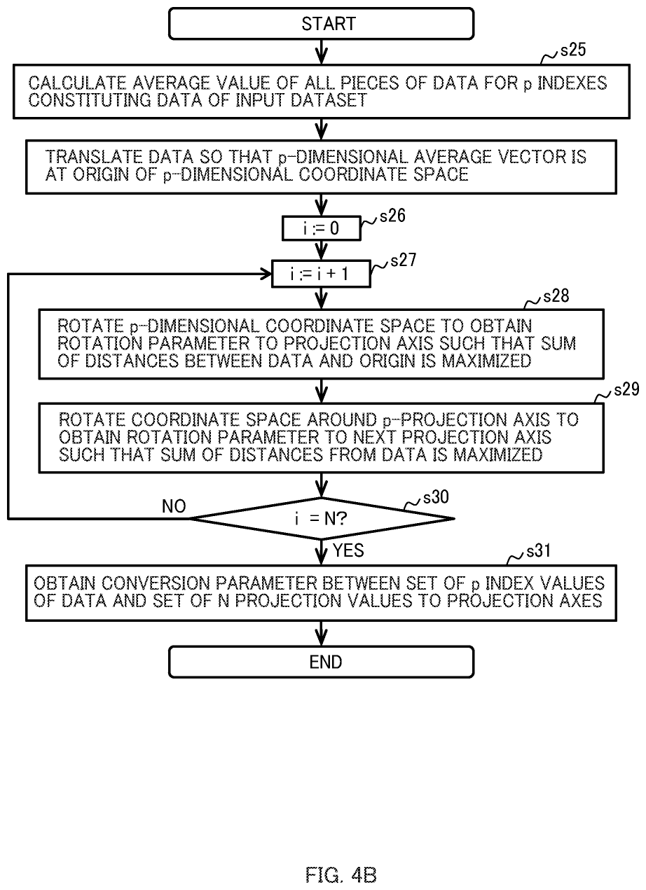

The process of adjusting the parameters in s3 described above will be described with reference to FIGS. 4A and 4B. FIG. 4A illustrates a process flow of a process of adjusting the parameters of the feature vector extraction unit 112 and the data generation unit 116 in a case where these units are implemented by a neural network, and FIG. 4B illustrates a process flow of a process of adjusting the parameters of the feature vector extraction unit 112 and the data generation unit 116 in a case where these units are implemented by a logic program.

In the case of FIG. 4A, the learning dataset generation support device 100 inputs the data of the input dataset to the encoder and inputs an output of the encoder to the decoder (s20).

Further, the learning dataset generation support device 100 adjusts the parameters of the encoder so that the difference between a distribution of N-dimensional features and an N-dimensional Gaussian distribution, which are generated by the encoder from the input dataset is reduced (s21).

Further, the learning dataset generation support device 100 adjusts the parameters of the encoder and the decoder so that the difference between data generated by the decoder from the N-dimensional feature vectors and the data in the input dataset is reduced (s22), and then the processing ends.

In other words, the network parameters are adjusted by a method such as a variational autoencoder (VAE) so that a predetermined objective function value in reinforcement learning using the input dataset is minimized. For example, in a case of using the VAE, the objective function represents the difference between the distribution of N-dimensional features and the N-dimensional Gaussian distribution, which are generated by the encoder from the input dataset, and the difference between the data generated by the decoder from the N-dimensional feature vectors and the data in the input dataset.

On the other hand, in FIG. 4B, the learning dataset generation support device 100 calculates an average value of all pieces of data for p indexes constituting the data of the input dataset (s25).

Further, the learning dataset generation support device 100 translates the data so that the p-dimensional average vector is at the origin of a p-dimensional coordinate space (s26).

Further, the learning dataset generation support device 100 sets a variable i to 0 (s26) and increments the variable i by one repeatedly according to the execution of s30 described later (s27).

Further, the learning dataset generation support device 100 rotates the p-dimensional coordinate space to obtain a rotation parameter to a projection axis such that the sum of the distances between the data and the origin is maximized (s28).

Further, the learning dataset generation support device 100 rotates the coordinate space around the p-projection axis to obtain a rotation parameter to a next projection axis such that the sum of the distances from the data is maximized (s29).

When the value of i becomes N (dimension) as a result of the increment (s30) (s30: YES), the learning dataset generation support device 100 obtains a conversion parameter between a set of p index values of the data and a set of N projection values to the projection axes (s31), and then the processing ends.

<<Learning Dataset Generation Support Method: Dimensionality Reduction Flow>>

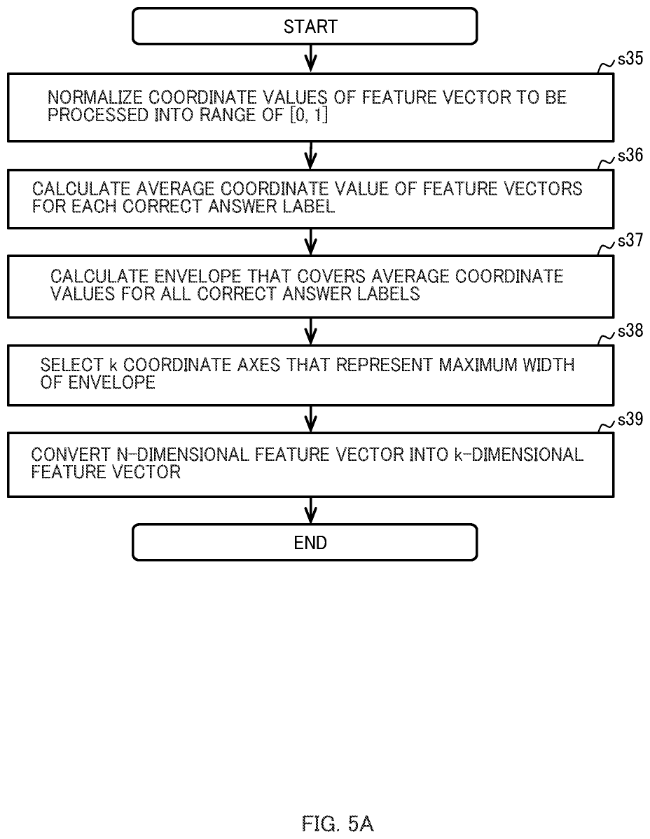

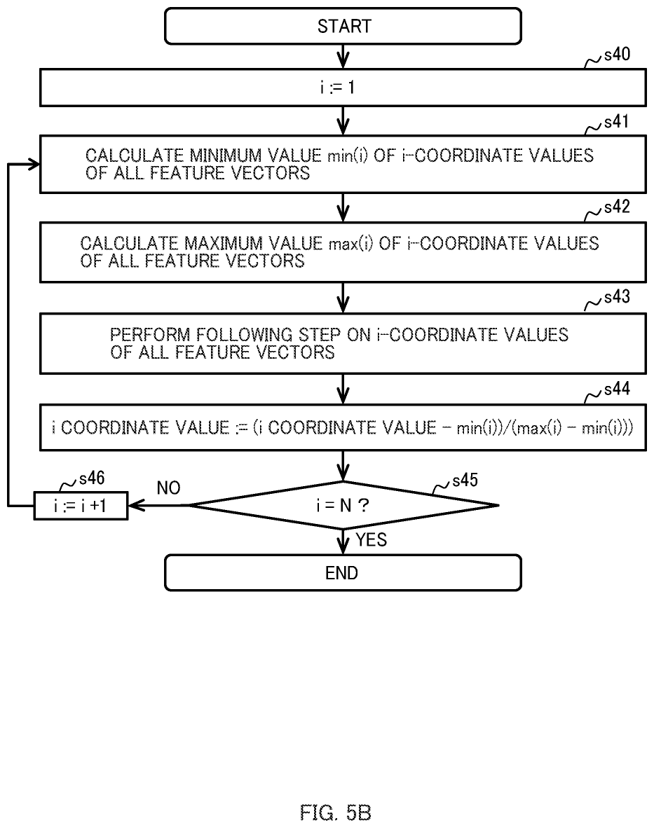

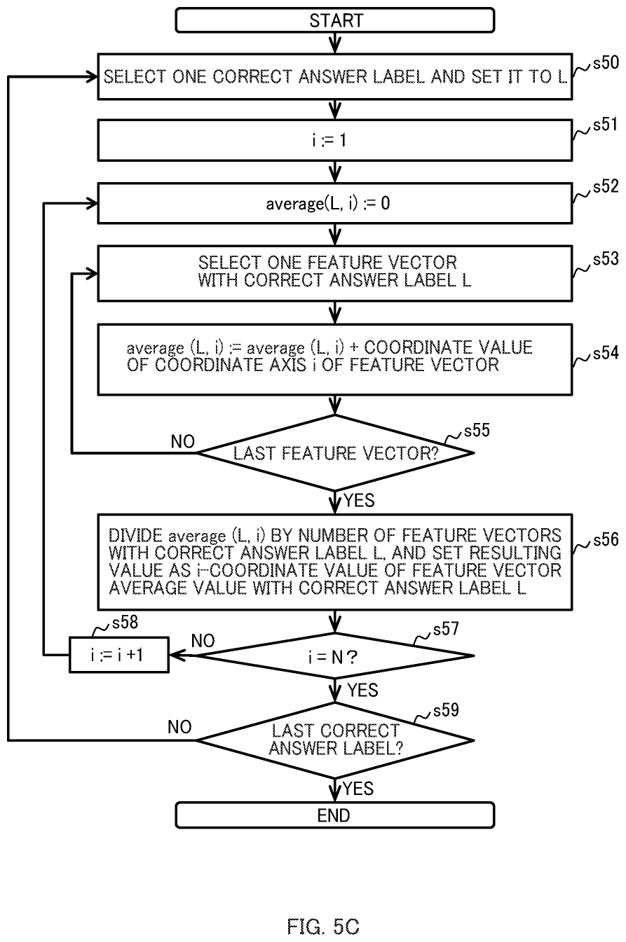

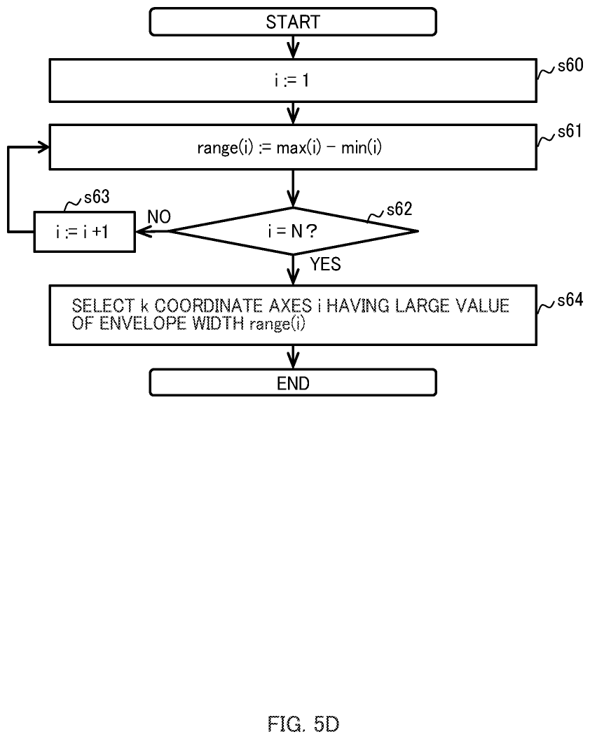

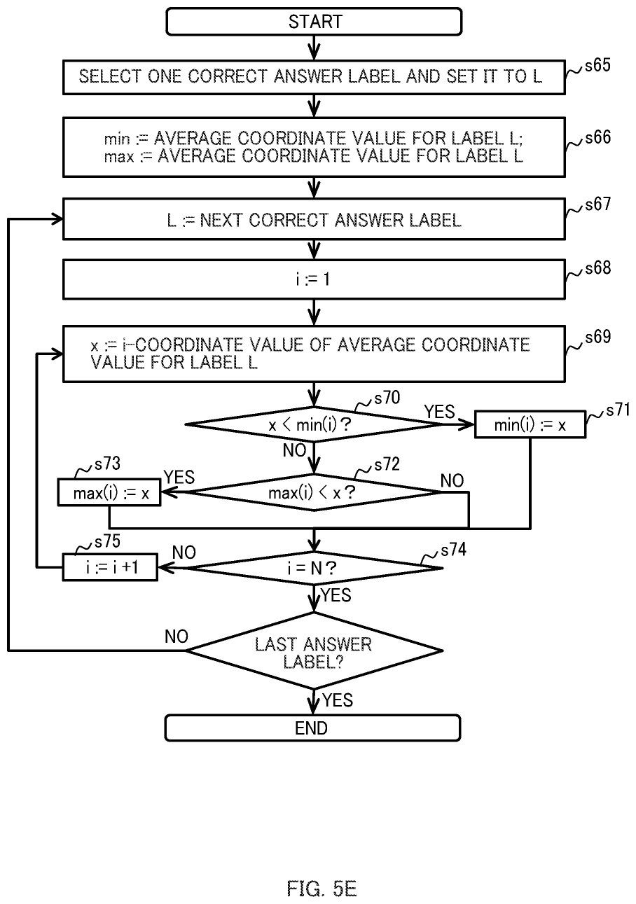

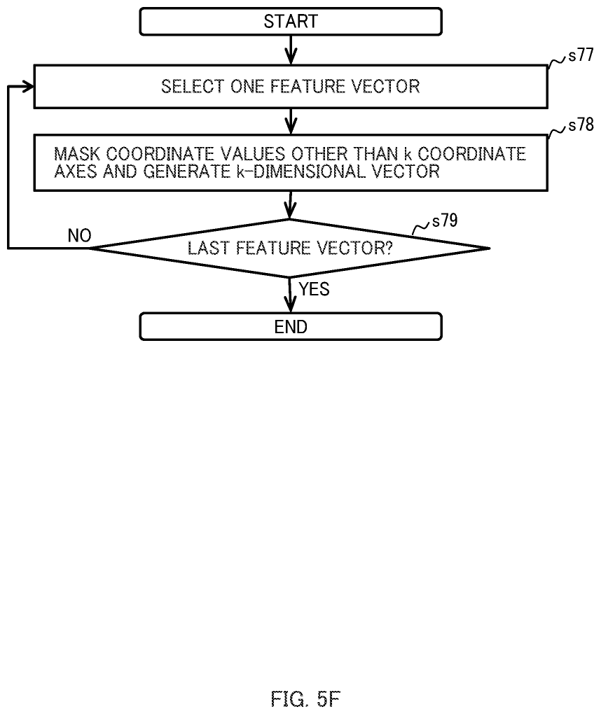

Subsequently, a process of dimensionality reduction in s6 described above will be described with reference to FIG. 5A. This dimensionality reduction process is a process of converting an N-dimensional feature vector into a k-dimensional vector that best matches the correct answer label.

In this case, the learning dataset generation support device 100 normalizes the coordinate values of the feature vector to be processed into a range of [0, 1] (s35).

Further, the learning dataset generation support device 100 calculates an average coordinate value of the feature vectors for each correct answer label (s36).

Further, the learning dataset generation support device 100 calculates an envelope that covers the average coordinate values for all the correct answer labels (s37).

Further, the learning dataset generation support device 100 selects k coordinate axes that represent the maximum width of the envelope (s38).

Further, the learning dataset generation support device 100 converts the N-dimensional feature vector into a k-dimensional feature vector (s39), and then the processing ends.

<<Learning Dataset Generation Support Method: Feature Vector Normalization Flow>>

In the dimensionality reduction process flow described above, the details of the normalization of s35 will be described with reference to FIG. 5B. In this normalization, the learning dataset generation support device 100 sets a variable i to 1 (s40) and increments the variable i by one repeatedly according to a result of determination in s45 described later (s46).

Subsequently, the learning dataset generation support device 100 calculates a minimum value min(i) of the i-coordinate values of all the feature vectors (s41).

Further, the learning dataset generation support device 100 calculates a maximum value max(i) of the i-coordinate values of all the feature vectors (s42).

Further, the learning dataset generation support device 100 performs s44 on the i-coordinate values of all the feature vectors (s43).

Further, the learning dataset generation support device 100 calculates i-coordinate value:=(i-coordinate value−min(i))/(max(i)−min(i)) (s44).

Further, if the value of the variable i is N (dimension) (s45: YES), the processing in the learning dataset generation support device 100 ends.

<<Learning Dataset Generation Support Method: Average Coordinate Value Calculation Flow>>

Subsequently, in the dimensionality reduction process flow, the details of the calculation of s36 will be described with reference to FIG. 5C. In this calculation, the learning dataset generation support device 100 selects one correct answer label and sets it as L (s50).

Further, the learning dataset generation support device 100 sets a variable i to 1 (s51) and increments the variable i by one repeatedly according to a result of determination in s57 described later (s58).

Subsequently, the learning dataset generation support device 100 initializes an array variable average (L, i) to 0 (s52).

Further, the learning dataset generation support device 100 selects one feature vector with a correct answer label of L (s53).

Further, the learning dataset generation support device 100 adds the coordinate value of the coordinate axis i of the feature vector to the average (L, i) (s54).

Subsequently, the learning dataset generation support device 100 determines whether it is the last feature vector (s55), and if it is not the last feature vector (s55: NO), the processing returns to s53.

On the other hand, if it is the last feature vector as a result of the determination (s55: YES), the learning dataset generation support device 100 divides the average (L, i) by the number of feature vectors with the correct answer label L, and sets the resulting value as the i-coordinate value of the feature vector average value with the correct answer label L (s56).

Further, if the variable i is N (s57: YES), the learning dataset generation support device 100 determines whether or not it is the last correct answer label (s59).

If it is not the last correct answer label as a result of the determination (s59: NO), then the processing in the learning dataset generation support device 100 returns to s50. On the other hand, if it is the last correct answer label (s59: YES), then the processing in the learning dataset generation support device 100 ends.

<<Learning Dataset Generation Support Method: Average Coordinate Value Envelope Calculation Flow>>

Subsequently, in the dimensionality reduction process flow, the details of the calculation of s37 will be described with reference to FIG. 5D. In this calculation, the learning dataset generation support device 100 sets a variable i to 1 (s60) and increments the variable i by one repeatedly according to a result of determination in s62 described later (s63).

Subsequently, the learning dataset generation support device 100 calculates range(i):=max(i)−min(i) (s61).

Further, if the variable i reaches N (s62: YES), the learning dataset generation support device 100 selects k coordinate axes i having a large value of the envelope width range(i) (s64), and then the processing ends.

<<Learning Dataset Generation Support Method: Coordinate Axis Selection Flow>>

Subsequently, in the dimensionality reduction process flow, the details of the selection of s38 will be described with reference to FIG. 5E. In this selection, the learning dataset generation support device 100 selects one correct answer label and sets it as L (s65).

Further, the learning dataset generation support device 100 sets the average coordinate value for the label L as the initial value for the minimum coordinate value and maximum coordinate value of the envelope (s66), and performs subsequent steps on the average coordinate values for the remaining correct answer labels.

Specifically, the learning dataset generation support device 100 selects the next correct answer label L (s67) and sets a variable i (coordinate axis) to 1 (s68).

Further, the learning dataset generation support device 100 sets a variable x to the value of the coordinate axis i of the average coordinate value for the label L selected in s67 (s69), and determines whether the variable x is smaller than the value of the coordinate axis i of the minimum coordinate value of the envelope (s70).

If the variable x is smaller than the value of the coordinate axis i of the minimum coordinate value of the envelope as a result of the determination (s70: YES), the learning dataset generation support device 100 updates the value of the coordinate axis i of the minimum coordinate value to the value of the variable x (s71), and then the processing proceeds to s74.

On the other hand, if the variable x is not smaller than the value of the coordinate axis i of the minimum coordinate value of the envelope as a result of the determination (s70: NO), the learning dataset generation support device 100 determines whether the variable x is larger than the value of the coordinate axis i of the maximum coordinate value of the envelope (s72).

If the variable x is larger than the value of the coordinate axis i of the maximum coordinate value of the envelope as a result of the determination (s72: YES), the learning dataset generation support device 100 updates the value of the coordinate axis i of the maximum coordinate value to the value of the variable x (s73), and then the processing proceeds to s74.

On the other hand, if the variable x is not larger than the value of the coordinate axis i of the maximum coordinate value of the envelope as a result of the determination (s72: NO), then the processing in the learning dataset generation support device 100 proceeds to s74.

Further, the learning dataset generation support device 100 determines whether or not the variable i is N (s74), and if the variable i is N as a result of the determination (s74: YES), then the processing proceeds to s76.

Subsequently, the learning dataset generation support device 100 determines whether the last correct answer label is reached (s76), and if the last correct answer label is not reached (s76: NO), then the processing returns to s67.

On the other hand, if the last correct answer label is reached as a result of the determination (s76: YES), then the processing in the learning dataset generation support device 100 ends.

<<Learning Dataset Generation Support Method: Feature Vector Conversion Flow>>

Subsequently, in the dimensionality reduction process flow, the details of the conversion of s39 will be described with reference to FIG. 5F. In this conversion, the learning dataset generation support device 100 selects one feature vector from the feature vectors to be processed (s77).

Subsequently, the learning dataset generation support device 100 masks the coordinate values other than those of the k coordinate axes and generates a k-dimensional vector (s78).

Subsequently, the learning dataset generation support device 100 determines whether the step of s78 has been executed for the last feature vector of the feature vectors to be processed (s79).

If the target for the step of s78 is the last feature vector as a result of the determination (s79: YES), then the processing in the learning dataset generation support device 100 ends.

<<Learning Dataset Generation Support Method: Feature Vector Collection Flow>>

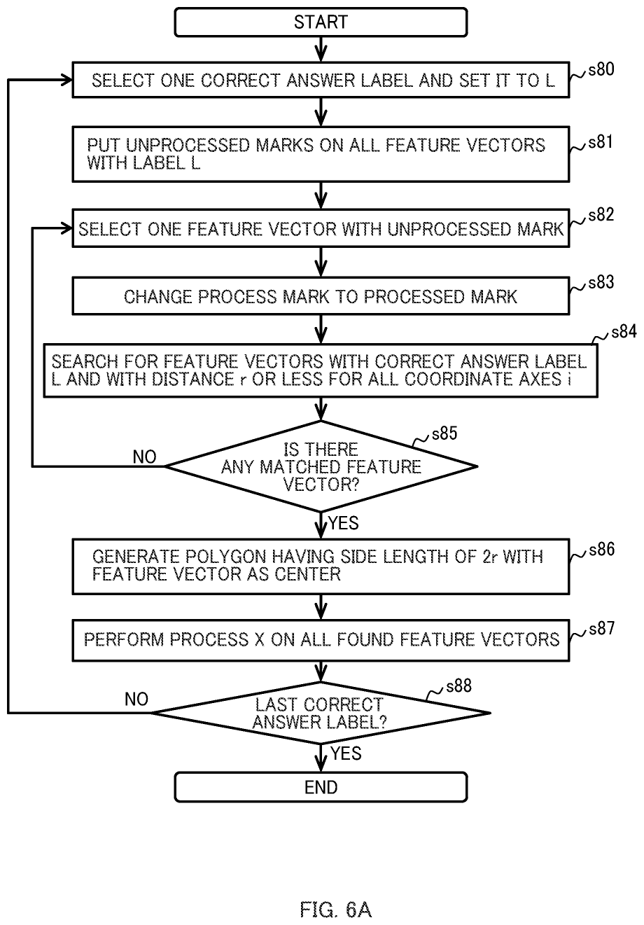

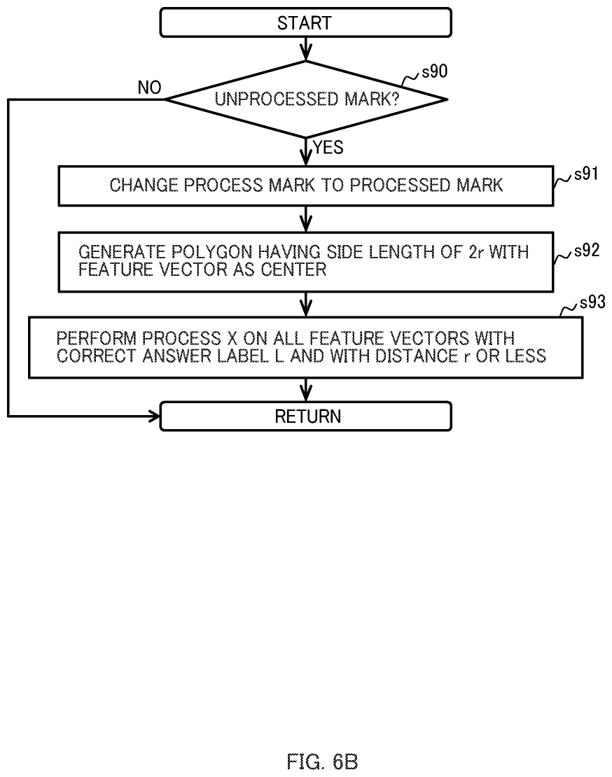

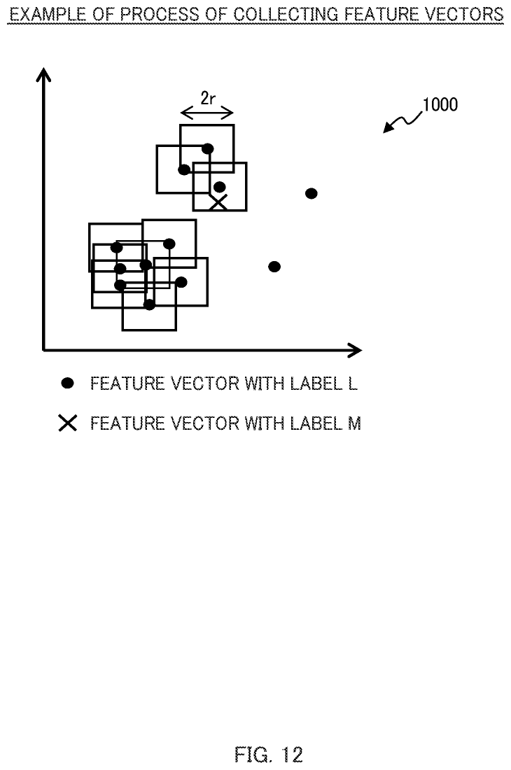

Subsequently, the flow of a process of collecting the feature vectors related to s5 in the main flow of FIG. 3 will be described with reference to FIGS. 6A, 6B, and 12.

In this process, the learning dataset generation support device 100 selects one correct answer label and sets it as L (s80).

Further, the learning dataset generation support device 100 puts unprocessed marks on all the feature vectors with the label L (s81), and selects one of them (s82).

Subsequently, the learning dataset generation support device 100 changes the unprocessed mark on the feature vector selected in s82 to a processed mark (s83), and searches for the feature vectors with the correct answer label L and with a predetermined distance r or less for all the coordinate axes i (s84).

If there is no matched feature vector as a result of the search (s85: NO), the processing in the learning dataset generation support device 100 returns to s82.

On the other hand, if there is any matched feature vector as a result of the search (s85: YES), the learning dataset generation support device 100 generates, as illustrated in a coordinate space 1000 of FIG. 12, a polygon (rectangle in the example of FIG. 12) having a side length of 2r with the feature vector with the label L selected in s82 as a center on the coordinate space (s86).

Subsequently, the learning dataset generation support device 100 performs a process X on all the feature vectors found by the search of s84 (s87).

Further, the learning dataset generation support device 100 determines whether the above-described steps have been performed on all the correct answer labels (s88), and if the steps have not been performed (s88: NO), then the processing returns to s80.

On the other hand, if the steps have been performed on all the correct answer labels as a result of the determination (s88: YES), then the processing in the learning dataset generation support device 100 ends.

Note that the flow of the process X is illustrated in FIG. 6B. The learning dataset generation support device 100 that performs the process X determines whether the above-mentioned process mark is the unprocessed mark (s90), and if the process mark is not the unprocessed mark, that is, if the process mark is the processed mark (s90: NO), then the processing ends.

On the other hand, if the process mark is the unprocessed mark as a result of the determination (s90: YES), the learning dataset generation support device 100 changes the process mark for the feature vector to the processed mark (s91).

Subsequently, the learning dataset generation support device 100 generates a polygon having a side length of 2r with the feature vector to be processed as a center on the coordinate space (s92).

Further, the learning dataset generation support device 100 recursively performs the process X on all the feature vectors with the correct answer label L and with a distance r or less (s93), and then the processing ends.

<<Learning Dataset Generation Support Method: Parameter Adjustment and Data Generation Flow>>

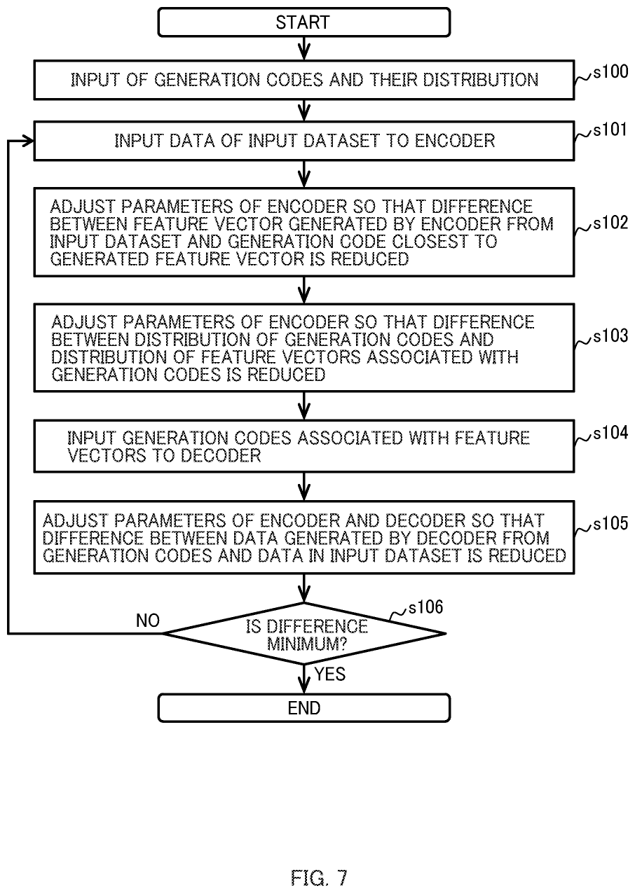

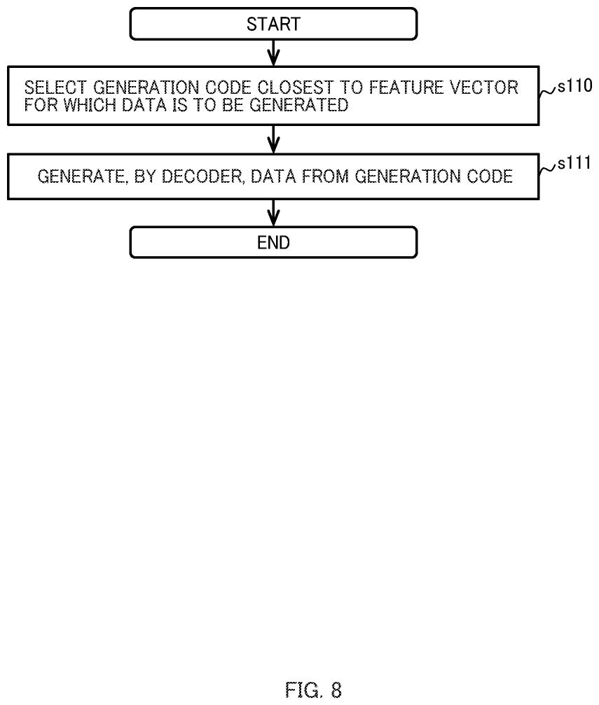

Subsequently, an example of the process of adjusting the parameters of the feature vector extraction unit 112 and the data generation unit 116 and an example of generating data, using generation codes will be described with reference to FIGS. 7 and 8, respectively.

In this adjustment, the learning dataset generation support device 100 receives input of generation codes and their distribution from, for example, the operator (s100). Examples of the generation codes include a set of values such as 0.12, 0.45, 1.56, . . . , 0.33. Examples of the distribution of the generation codes can include a uniform association between the feature vectors and all the generation codes.

Further, the learning dataset generation support device 100 inputs the dataset to the feature vector extraction unit 112 (s101).

Subsequently, the learning dataset generation support device 100 adjusts the parameters of the feature vector extraction unit 112 so that the difference between the feature vector generated by the feature vector extraction unit 112 from the dataset and the generation code closest to the generated feature vector is reduced (s102).

Further, the learning dataset generation support device 100 adjusts the parameters of the feature vector extraction unit 112 so that the difference between the distribution of the generation codes and the distribution of the feature vectors associated with the generation codes is reduced (s103).

Subsequently, the learning dataset generation support device 100 inputs the generation codes associated with the feature vectors to the data generation unit 116 (s104).

Further, the learning dataset generation support device 100 adjusts the parameters of the feature vector extraction unit 112 and the data generation unit 116 so that the difference between the data generated by the data generation unit 116 from the generation codes and the data in the dataset of s101 is reduced (s105).

Subsequently, if the difference between the data generated by the data generation unit 116 from the generation codes and the data in the dataset of s101 is minimized as a result of the adjustment in s105 (s106: YES), then the processing in the learning dataset generation support device 100 ends.

On the other hand, as illustrated in FIG. 8, the data generation unit 116 selects a generation code closest to the feature vector for which data is to be generated (s110), and generates data from the selected generation code (sill), and then the processing ends.

<<Learning Dataset Generation Support Method: Feature Vector Display Flow>>

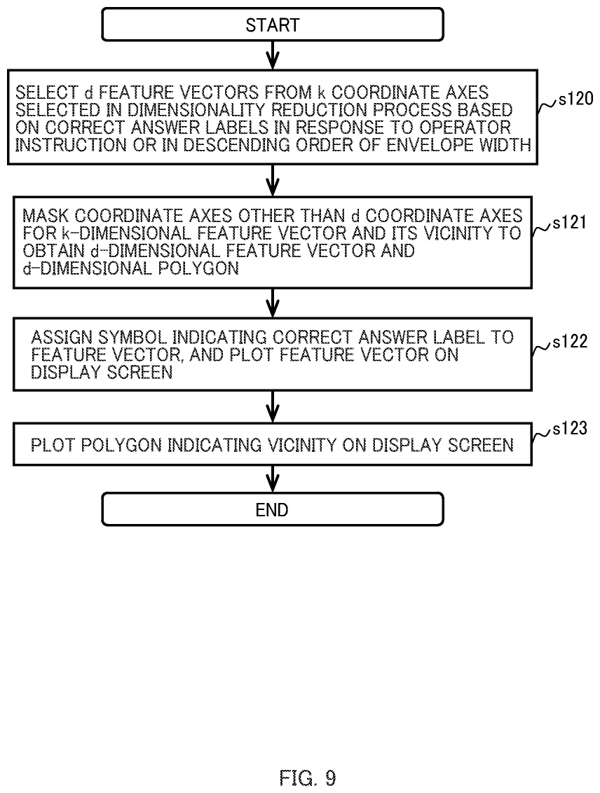

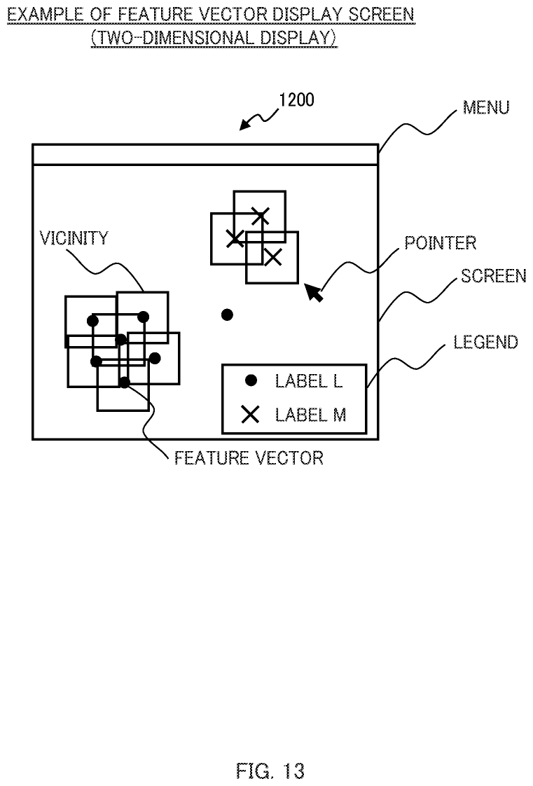

Subsequently, a process of displaying the feature vectors will be described with reference to FIGS. 9 and 13. For example, this display process can be performed in interaction with the operator during the editing process of s7 in the flow of FIG. 3.

The learning dataset generation support device 100 selects d feature vectors from k coordinate axes selected in the dimensionality reduction process based on the correct answer labels (above-described flow in FIG. 5A) in response to an operator instruction or in descending order of envelope width (s120).

Further, the learning dataset generation support device 100 masks the coordinate axes other than the d coordinate axes for the k-dimensional feature vector and its vicinity (example: a rectangular range with each side of 2r) to obtain a d-dimensional feature vector and a d-dimensional polygon (s121).

Subsequently, the learning dataset generation support device 100 assigns a symbol indicating the correct answer label to the feature vector, and plots the feature vector on the coordinate plane (s122).

Further, the learning dataset generation support device 100 plots the polygon indicating the vicinity of each feature vector on a display screen (s123), and then the processing ends.

<<Learning Dataset Generation Support Method: Feature Vector Editing Flow>>

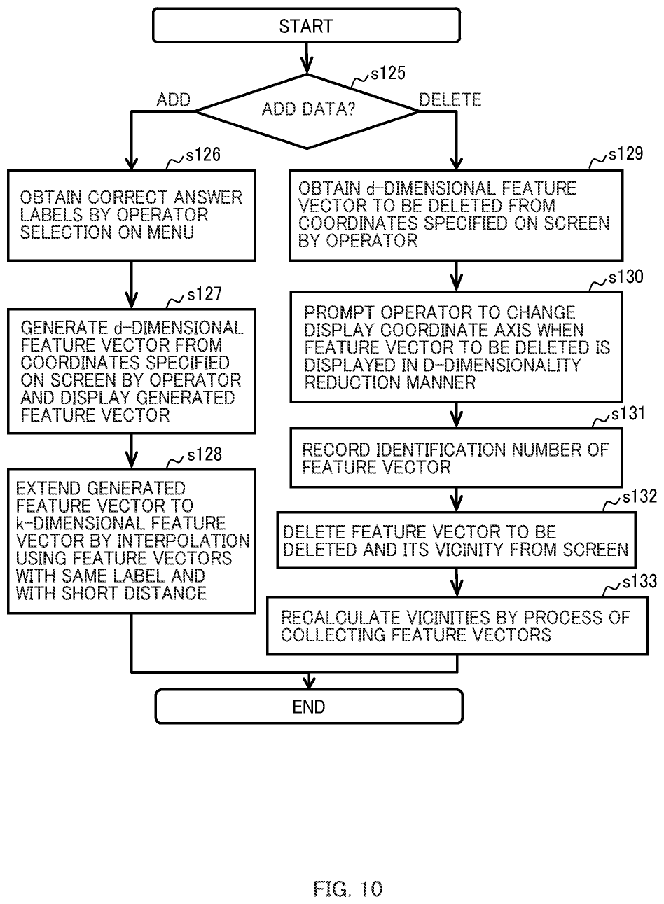

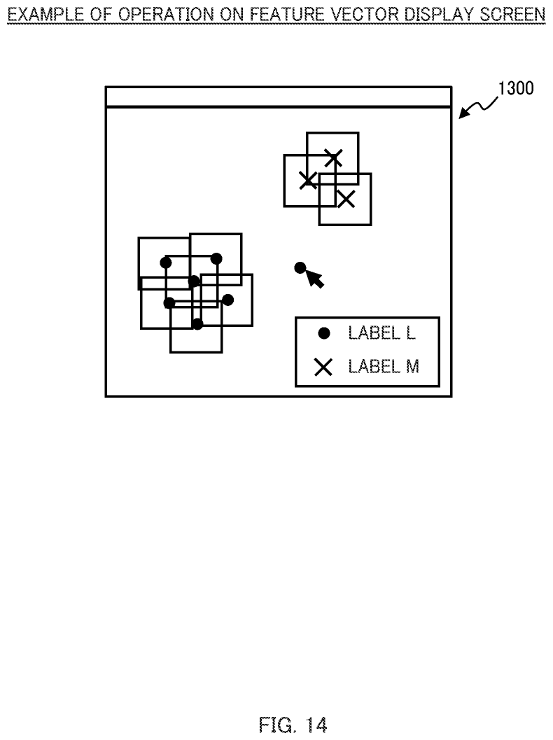

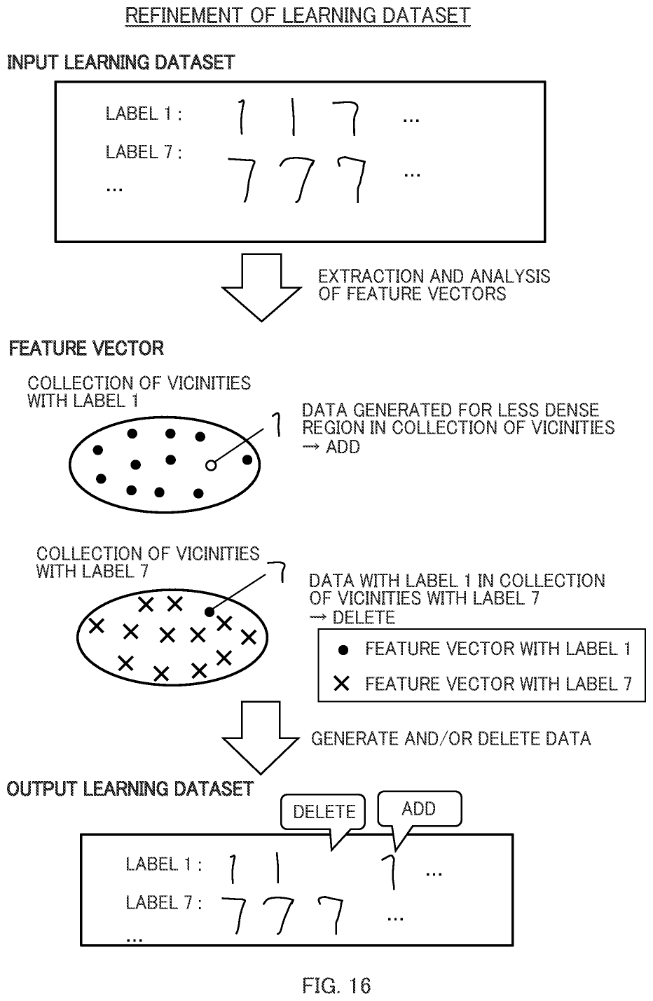

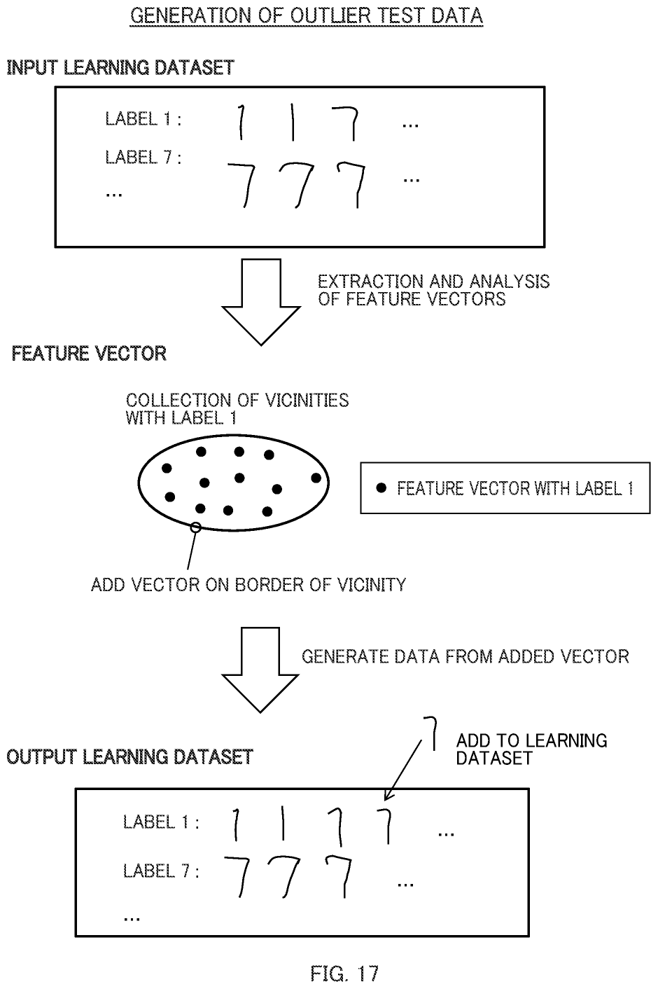

Subsequently, an example of the process of editing the feature vectors in accordance with an instruction from the operator will be described with reference to FIGS. 10, 14, and 15. Further, concrete images of such editing, that is, refinement of learning data, are illustrated in FIGS. 16 and 17.

First, the learning dataset generation support device 100 determines whether or not the instruction from the operator is to add a feature vector (s125).

If the instruction is to add as a result of the determination (s125: ADD), the learning dataset generation support device 100 obtains correct answer labels by an operator selection on a menu (s126). In an example of FIG. 16, association of pieces of learning data (images of number “1” and images of number “7”) with correct answer labels “1” and “7” is illustrated.

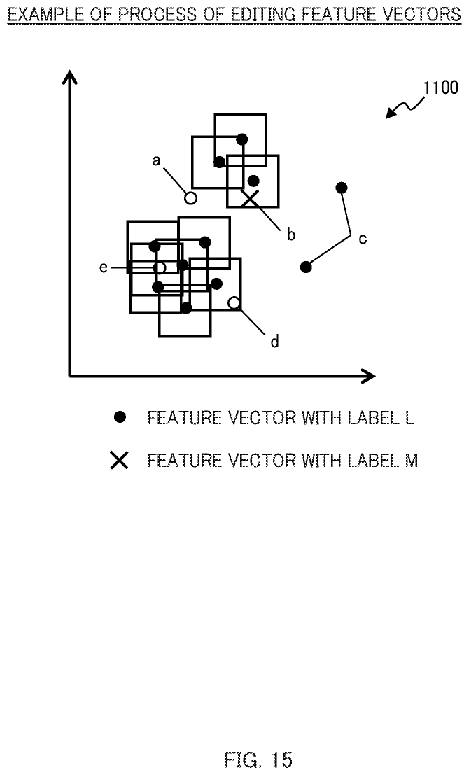

Subsequently, the learning dataset generation support device 100 generates a d-dimensional feature vector from the coordinates specified on a screen by the operator and displays the generated feature vector (s127). Examples of the feature vector to be generated and displayed can include point a (feature vector connecting the vicinities of feature vectors with the same label) and point d (feature vector on the boundary of a vicinity) in FIG. 15.

In the example of FIG. 16, a case is illustrated in which a feature vector is added in a region where the density of the feature vectors is low in a collection of the vicinities with the correct answer label “1”. Further, in an example of FIG. 17, a case is illustrated in which a feature vector is added on the boundary in a collection of the vicinities with the correct answer label “1”.

Further, the learning dataset generation support device 100 extends the generated feature vector to a k-dimensional feature vector by interpolation using feature vectors with the same label and with a short distance (s128), and then the processing ends.

On the other hand, if the instruction is to delete as a result of the determination in s125 (s125: DELETE), the learning dataset generation support device 100 obtains the d-dimensional feature vector to be deleted, from the coordinates specified on the screen by the operator (s129).

Examples of the feature vector to be deleted can include point b (feature vector with another label in the vicinity), point c (feature vector isolated outside the vicinities), and point e (excessive feature vector in the vicinities) in FIG. 15. In the example of FIG. 16, a case is illustrated in which the feature vector with the correct answer label “1” is deleted in the collection of the vicinities with the correct answer label “7”.

Further, the learning dataset generation support device 100 notifies the operator of a message prompting the operator to change the display coordinate axis when the feature vector to be deleted is displayed in a d-dimensionality reduction manner (s130).

Subsequently, the learning dataset generation support device 100 records the identification number of the feature vector in, for example, the memory 103 (s131).

Further, the learning dataset generation support device 100 deletes the feature vector to be deleted and its vicinity from the screen (s132).

Subsequently, the learning dataset generation support device 100 recalculates the vicinities by the process of collecting the feature vectors (s133), and then the processing ends.

<<Learning Dataset Generation Support Method: Continuous Learning Data Generation Flow>>

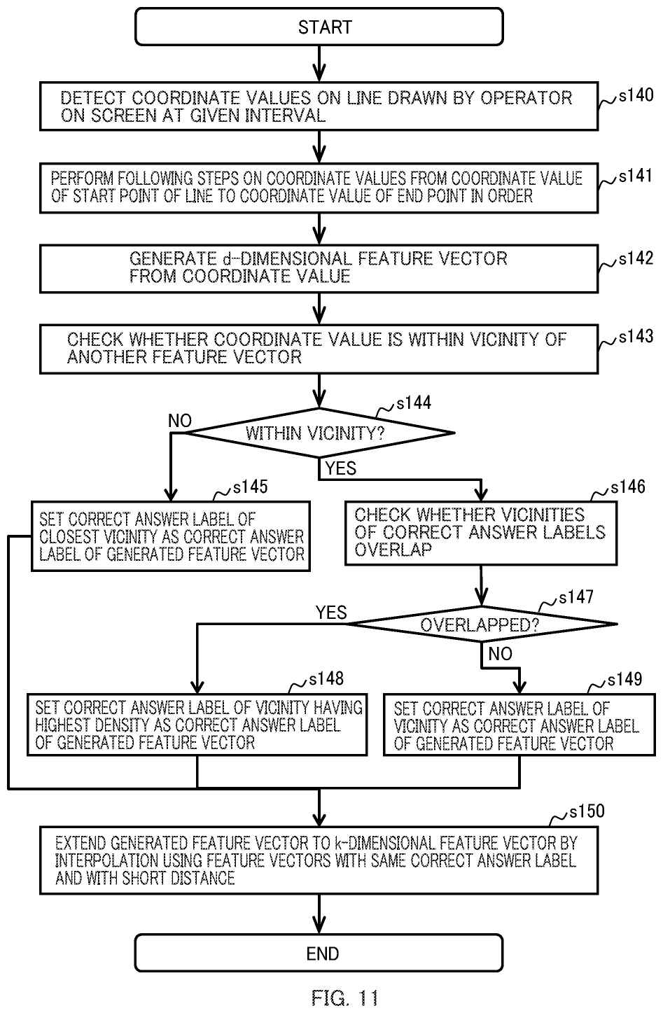

Subsequently, the flow of generating continuous learning data will be described with reference to FIGS. 11, 18, and 19.

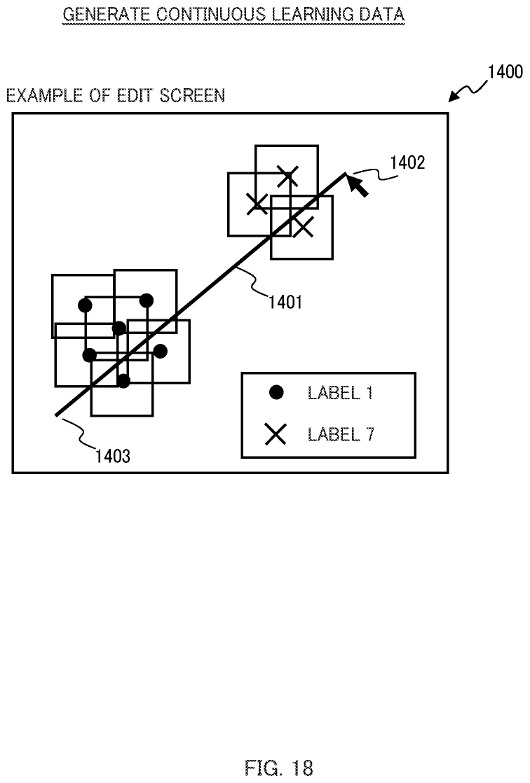

In this generation, the learning dataset generation support device 100 detects the coordinate values on a line segment 1401 drawn by the operator on a screen 1400 (FIG. 18) at a given interval (s140).

Further, the learning dataset generation support device 100 performs the following steps on the coordinate values from the coordinate value of a start point 1402 of the line segment 1401 to the coordinate value of an end point 1403 in order (s141).

Subsequently, the learning dataset generation support device 100 generates a d-dimensional feature vector from the coordinate value (s142).

Further, the learning dataset generation support device 100 checks whether the coordinate value is within the vicinity of another feature vector (s143).

Subsequently, the learning dataset generation support device 100 determines whether or not the result of the check indicates that the coordinate value is within the vicinity (s144).

If the coordinate value is not within the vicinity as a result of the determination (s144: NO), the learning dataset generation support device 100 sets the correct answer label of the closest vicinity as the correct answer label of the generated feature vector (s145), and then the processing proceeds to s150.

On the other hand, if the coordinate value is within the vicinity as a result of the determination (s144: YES), the learning dataset generation support device 100 checks whether a plurality of vicinities of correct answer labels overlap (s146).

Further, the learning dataset generation support device 100 determines whether the result of the check indicates that a plurality of vicinities of correct answer labels overlap (s147).

If a plurality of vicinities of correct answer labels overlap as a result of the determination (s147: YES), the learning dataset generation support device 100 sets the correct answer label of the vicinity having the highest density as the correct answer label of the generated feature vector (S148).

On the other hand, if a plurality of vicinities of correct answer labels do not overlap as a result of the determination (s147: NO), the learning dataset generation support device 100 sets the correct answer label of the vicinity as the correct answer label of the generated feature vector (S149).

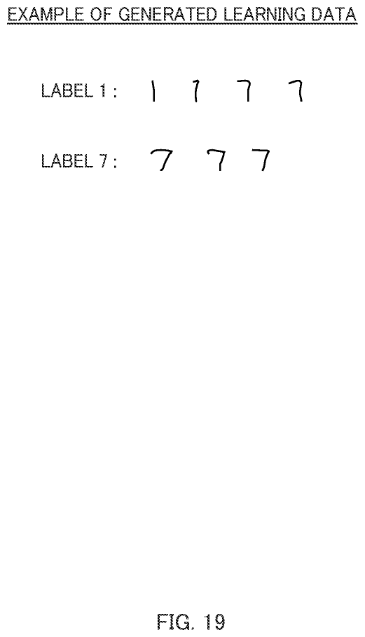

Subsequently, the learning dataset generation support device 100 extends the generated feature vector to a k-dimensional feature vector by interpolation using feature vectors with the same correct answer label and with a short distance (s150), and then the processing ends. An example of the learning data generated in this way is, as illustrated in FIG. 19, a set of pieces of learning data that shows, with respect to the correct answer label “1”, a continuous transition from an image that is most likely to be “1” to an image similar to another label (example: “7”). Similarly, an example with respect to the correct answer label “7” is a set of pieces of learning data that shows a continuous transition from an image that is most likely to be “7” to an image similar to another label (example: “1”).

Although the above description is specific for the best mode for carrying out the present disclosure, the present disclosure is not limited to this, and various modifications are possible without departing from the spirit and scope of the disclosure.

In the above-described embodiment, collecting the feature vectors extracted by the encoder based on the correct answer labels makes it possible to detect data with a feature different from learning intention for a correct answer label, detect excessive or deficient learning data for the correct answer label, and detect data with a similar feature but with a different correct answer label.

In addition, deleting a feature vector based on the correct answer label makes it possible to remove data having an inappropriate feature for the detected correct answer label, remove redundant learning data for the detected correct answer label, and sort out data with a similar feature detected above and a different correct answer label.

In addition, generating a feature vector along with a correct answer label and generating data using a decoder makes it possible to supplement deficient learning data for the detected correct answer label, supplement extreme learning data at the boundary of a collection of correct answer labels, and supplement learning data with the correct answer label and feature specified by an operator.

Accordingly, it is possible to efficiently and appropriately refine a learning dataset used for supervised machine learning.

At least the following will be made clear by the description in the present specification. In the learning dataset generation support device according to the present embodiment, the computing device may perform a process of analyzing the extracted feature vectors based on a correct answer label in the editing process, and add and/or delete a feature vector according to a result of analyzing.

This makes the process of adding and deleting a feature vector more accurate. As a result, it is possible to more efficiently and appropriately refine a learning dataset used for supervised machine learning.

Further, in the learning dataset generation support device according to the present embodiment, the computing device may collect, in analyzing the feature vectors, feature vectors having the same correct answer label and a distance between the vectors, the distance being a predetermined threshold value or less.

This makes it possible to efficiently extract a group of suitable feature vectors that may be targets for subsequent editing. As a result, it is possible to more efficiently and appropriately refine a learning dataset used for supervised machine learning.

Further, in the learning dataset generation support device according to the present embodiment, the computing device may add, in the editing process, a feature vector in a region where a vector density is lower than a predetermined threshold value in a group of the collected feature vectors.

This makes it possible to avoid a loss of learning data in the input data space. As a result, it is possible to more efficiently and appropriately refine a learning dataset used for supervised machine learning.

Further, in the learning dataset generation support device according to the present embodiment, the computing device may delete, in the editing process, a feature vector having a distance from a group of the collected feature vectors and a different correct answer label, the distance being a predetermined threshold value or less.

This makes it possible to delete the feature vector that may adversely affect the robustness of the learning model. As a result, it is possible to more efficiently and appropriately refine a learning dataset used for supervised machine learning.

Further, in the learning dataset generation support device according to the present embodiment, the computing device may add, in the editing process, a feature vector on an edge of a group of the collected feature vectors.

This makes it possible to add a feature vector that enhances the robustness of the learning model. As a result, it is possible to more efficiently and appropriately refine a learning dataset used for supervised machine learning.

Further, in the learning dataset generation support device according to the present embodiment, the computing device may further delete, in the editing process, a vector in a region where a vector density is higher or lower than a predetermined threshold value in a group of the collected feature vectors.

This makes it possible to avoid the generation of learning data that may lead to an excessively biased learning result (different from the intention). As a result, it is possible to more efficiently and appropriately refine a learning dataset used for supervised machine learning.

Further, in the learning dataset generation support device according to the present embodiment, the computing device may further perform a process of evaluating the feature vectors extracted from the learning data based on a distance in a feature vector space, and feeding back a result of evaluating to parameters used in a process of extracting the feature vectors.

This makes it possible to improve the processing accuracy in the encoder. As a result, it is possible to more efficiently and appropriately refine a learning dataset used for supervised machine learning.

Further, in the learning dataset generation support device according to the present embodiment, the computing device may further perform a process of evaluating the learning data generated from the feature vectors based on a distance in a learning data space, and feeding back a result of evaluating to parameters used in a process of generating the learning data.

This makes it possible to improve the processing accuracy in the decoder. As a result, it is possible to more efficiently and appropriately refine a learning dataset used for supervised machine learning.

Further, in the learning dataset generation support device according to the present embodiment, the computing device may further perform a process of associating, in generating the learning data, the feature vector with any of predetermined generation codes, and operating a distribution of the association.

This makes it possible to improve the robustness of the learning model and improve the accuracy of the output result. As a result, it is possible to more efficiently and appropriately refine a learning dataset used for supervised machine learning.

Further, in the learning dataset generation support device according to the present embodiment, the computing device may further perform, in the editing process, a process of displaying the feature vectors by using a predetermined dimensional coordinate axis corresponding to a feature specified by an operator from among multiple dimensions or a feature selected based on a predetermined threshold value.

This makes it possible to convert the multidimensional feature vector into a dimension that can be recognized by an operator and is meaningful as a learning target. As a result, it is possible to more efficiently and appropriately refine a learning dataset used for supervised machine learning.

Further, in the learning dataset generation support device according to the present embodiment, the computing device may further perform, in the editing process, a process of editing the feature vectors in accordance with an instruction from an operator.

This makes it possible to allow a knowledgeable operator to edit the feature vector. As a result, it is possible to more efficiently and appropriately refine a learning dataset used for supervised machine learning.

Further, in the learning dataset generation support device according to the present embodiment, the computing device may repeatedly perform a series of processes of extracting the feature vectors, analyzing the feature vectors, editing the feature vectors, and generating the learning data until an evaluation value for the feature vectors based on a predetermined index reaches a predetermined threshold value.

This makes it possible to efficiently generate the learning dataset from the viewpoint of refining the feature vectors. As a result, it is possible to more efficiently and appropriately refine a learning dataset used for supervised machine learning.

What is claimed is:

1. A learning dataset generation support device comprising:
a storage device configured to store a plurality of pieces of learning data used for supervised machine learning along with correct answer labels; and
a computing device configured to perform a process of sequentially acquiring the pieces of learning data from the storage device to extract feature vectors, an editing process of adding and/or deleting a feature vector according to a predetermined algorithm, and a process of generating learning data from the edited feature vectors.

2. The learning dataset generation support device according to claim 1, wherein
the computing device is configured to perform, in the editing process, a process of analyzing the extracted feature vectors based on a correct answer label, and adding and/or deleting a feature vector according to a result of analyzing.

3. The learning dataset generation support device according to claim 2, wherein
the computing device is configured to collect, in analyzing the feature vector, feature vectors having a same correct answer label and a distance between the vectors, the distance being a predetermined threshold value or less.

4. The learning dataset generation support device according to claim 3, wherein
the computing device is configured to add, in the editing process, a feature vector in a region where a vector density is lower than a predetermined threshold value in a group of the collected feature vectors.

5. The learning dataset generation support device according to claim 3, wherein
the computing device is configured to delete, in the editing process, a feature vector having a distance from a group of the collected feature vectors and a different correct answer label, the distance being a predetermined threshold value or less.

6. The learning dataset generation support device according to claim 3, wherein
the computing device is configured to add, in the editing process, a feature vector on an edge of a group of the collected feature vectors.

7. The learning dataset generation support device according to claim 3, wherein
the computing device is configured to further delete, in the editing process, a vector in a region where a vector density is higher or lower than a predetermined threshold value in a group of the collected feature vectors.

8. The learning dataset generation support device according to claim 1, wherein
the computing device is configured to further perform a process of evaluating the feature vectors extracted from the learning data based on a distance in a feature vector space, and feeding back a result of evaluating to parameters used in a process of extracting the feature vector.

9. The learning dataset generation support device according to claim 1, wherein
the computing device is configured to further perform a process of evaluating the learning data generated from the feature vectors based on a distance in a learning data space, and feeding back a result of evaluating to parameters used in a process of generating the learning data.

10. The learning dataset generation support device according to claim 1, wherein
the computing device is configured to further perform a process of associating, in generating the learning data, the feature vector with any of predetermined generation codes, and operating a distribution of the association.

11. The learning dataset generation support device according to claim 1, wherein
the computing device is configured to further perform, in the editing process, a process of displaying the feature vectors by using a predetermined dimensional coordinate axis corresponding to a feature specified by an operator from among multiple dimensions or a feature selected based on a predetermined threshold value.

12. The learning dataset generation support device according to claim 1, wherein
the computing device is configured to further perform, in the editing process, a process of editing the feature vectors in accordance with an instruction from an operator.

13. The learning dataset generation support device according to claim 1, wherein
the computing device is configured to repeatedly perform a series of processes of extracting the feature vectors, editing the feature vectors, and generating the learning data until an evaluation value for the feature vectors based on a predetermined index reaches a predetermined threshold value.

14. A learning dataset generation support method performed by an information processing device including a storage device that is configured to store a plurality of pieces of learning data used for supervised machine learning along with correct answer labels, the learning dataset generation support method comprising
a process of sequentially acquiring the pieces of learning data from the storage device to extract feature vectors, an editing process of adding and/or deleting a feature vector according to a predetermined algorithm, and a process of generating learning data from the edited feature vectors.
